(19) United States
(12) Patent Application Publication
(10) Pub. No.: US 2026/0038026 A1
(43) Pub. Date: Feb. 5, 2026

(54) SYSTEM AND METHOD FOR GENERATING PERSONALIZED RECOMMENDATIONS

(71) Applicant: Cosnetix, LLC, Jersey Village, TX (US)

(72) Inventors: Diana M. Salha, Houston, TX (US); William C. Walker, Houston, TX (US); Greyson Newton, Jersey Village, TX (US)

(21) Appl. No.: 19/351,064

(22) Filed: Oct. 6, 2025

Related U.S. Application Data
(63) Continuation of application No. PCT/US2024/023149, filed on Apr. 4, 2024.
(60) Provisional application No. 63/494,165, filed on Apr. 4, 2023.

(51) Int. Cl. G06Q 30/0601; G06N 3/042

(52) U.S. Cl. CPC G06Q 30/0631; G06N 3/042

(57) ABSTRACT

The disclosure introduces a paradigm-shifting method and system for capitalizing on the expansive datasets generated from medical and biological research, employing a refined artificial intelligence framework designed to enhance individual well-being through personalized solutions. The disclosed system includes a sophisticated analytical engine adept at amalgamating and deciphering biologic data from genetic, environmental, and lifestyle sources to inform a diverse array of decisions spanning the healthcare and consumer product industries. The biologic data is processed using one or more neural networks, a mixture-of-expert models, or a combination of both. The neural networks and expert models are engineered to pinpoint essential biomarkers and interpret complex biologic datasets, thereby yielding actionable insights for personalized response determination. The utility of the system extends beyond the theoretical and ventures into the tangible, affecting everyday life.

### CROSS-REFERENCE TO RELATED APPLICATION

This application is a bypass continuation application of international application PCT/US2024/023149, entitled “SYSTEM AND METHOD FOR GENERATING PERSONALIZED RECOMMENDATIONS”, which claims the benefit of U.S. Provisional Application Ser. No. 63/494,165 filed by Greyson Newton, et al. on Apr. 4, 2023, entitled “SYSTEM AND METHOD FOR GENERATING PERSONALIZED RECOMMENDATIONS,” wherein both of the above applications are commonly assigned with the present disclosure and incorporated herein by reference in their entirety.

### TECHNICAL FIELD

This disclosure relates to artificial intelligent systems and, more specifically, to using biologic data and machine learning to provide personal recommendations uniquely tailored for an individual.

### BACKGROUND

Finding reliable and trustworthy sources of information to guide individuals in making personal product purchasing decisions can be challenging. Conflicting information online, mixed reviews, and product sponsorships often provide confusion and uncertainty about which products are the most suitable for an individual. Though attempts have been made to assist, the existing systems or methods present several disadvantages, such as limited personalization, biased recommendations towards the company's own products, and a lack of consideration for the individual's biologic data, such as their genetic makeup. The reliance on traditional data analysis methods has led to a generic approach in sectors where personalized solutions could offer groundbreaking benefits. For instance, in the cosmetic industry, the lack of a sophisticated analysis framework means consumers often resort to a trial-and-error process when selecting skincare products, a method fraught with inefficiencies, unnecessary expenses, and increased waste. Recognizing this problem, there is an opportunity to innovate and develop a solution tailored to the unique needs of individuals. Accordingly, a solution that is both personalized and effective would be beneficial.

### SUMMARY

In one aspect, the disclosure provides a method of generating personalized skincare product recommendations. In one example the method includes: (1) receiving user data that includes metadata and biologic data of a person, (2) generating multi-omic heatmaps that represent correlations among the biologic data and omic data, (3) determining, using a first neural network that is trained on a knowledge graph derived from multi-omic datasets, correlations between biological markers identified from the biologic data and adverse reactions to one or more skincare product ingredients, (4) generating a prompt context for a large language model (LLM) from the metadata and the multi-omic heatmaps, wherein the LLM is configured as a Biologically Embodied Multilayer Analysis System (BeMAS) with a Mixture of Experts (MoE) architecture, and (5) producing, using the prompt context and the LLM a personalized skincare product recommendation for the person that excludes products predicted to cause the adverse reactions.

In another aspect, a computing system for generating personalized skincare product recommendations is disclosed. In one example, the computing system includes: (1) an interface configured to receive user data that includes metadata and biologic data of a person and (2) one or more neural networks (NNs) to perform operations, wherein the operations include (2A) generating multi-omic heatmaps that represent correlations among the biologic data and omic data, (2B) determining, using a first one of the one or more neural networks that is trained on a knowledge graph derived from multi-omic datasets, correlations between biological markers identified from the biologic data and adverse reactions to one or more skincare product ingredients, (2C) generating a prompt context for a large language model (LLM) from the metadata and the multi-omic heatmaps, wherein the LLM is configured as a Biologically Embodied Multilayer Analysis System (BeMAS) with a Mixture of Experts (MoE) architecture, and (2D) producing, using the prompt context and the LLM a personalized skincare product recommendation for the person that excludes products predicted to cause the adverse reactions.

In yet another aspect, the disclosure provides computing system having one or more processors configured to perform operations. In one example, the operations include: (1) processing metadata and biological sequencing data of a person, wherein the processing includes integrating contextual information of the metadata with the biological sequencing data, (2) generating multi-omic heatmaps representing sequencing data from the biologic data, wherein the multi-omic heatmaps identify biological markers according to knowledge graphs derived from multi-omic datasets, (3) identifying correlations between the biological markers and adverse reactions to one or more ingredients of one or more beauty products, and (4) generating a personalized beauty product recommendation for the person according to the correlations and the metadata, wherein the beauty product recommendation excludes the one or more beauty products associated with the adverse reactions.

### BRIEF DESCRIPTION OF THE DRAWINGS

Reference is now made to the following descriptions taken in conjunction with the accompanying drawings, in which:

FIG. 1 illustrates a block diagram of an example of a personal recommendation system constructed according to the principles of the disclosure;

FIG. 2 illustrates a block diagram of an example of a BDAS configured to autonomously generate personalized recommendations according to the principles of the disclosure;

FIG. 3 illustrates an example of a pipeline used to generate the multi-omic knowledge graph of FIG. 2;

FIG. 4 portrays an example of a training process or regimen for encapsulating a ‘Mixture of Experts’ module;

FIG. 5 illustrates a block diagram of an example of a BDAS constructed according to the principles of the disclosure;

FIG. 6 illustrates a block diagram of another example of a BDAS constructed according to the principles of the disclosure; and

FIG. 7 illustrates a flow diagram of an example methodology that adeptly creates personalized product recommendations.

### DETAILED DESCRIPTION

Each individual is uniquely made and have their own biological makeup, or biologic data. As biotechnology and data analytics have progressed, a significant challenge has emerged: effectively interpreting and leveraging this biologic data, which includes genetic data and other omic data. Omic data is a collective term for comprehensive datasets derived from disciplines such as genomics, transcriptomics, proteomics, and metabolomics, among others. ‘Omics’ refers to the holistic study of the molecules that make up a cell, tissue, or organism, and how they interact to function as a system. The holistic study includes the analysis of genes (genomics), their resulting RNA transcripts (transcriptomics), the proteins they encode (proteomics), the metabolic processes they influence (metabolomics), and even the microbial communities present in the environment (metagenomics). Other omic fields include epigenomics, phenomics, and lipidomics.

The availability of biologic data provides the possibility of expanding the understanding of the complexities of living organisms. Current analytical tools, however, do not appear to have the ability to fully capitalize on the intricate interplay of the different biologic datasets, leaving many biological and health-related questions, ranging from the type of beauty products to use to the type of medicine to use, unanswered. For example, existing analytical tools often fail to provide the depth of personalization needed, are limited by biases in data interpretation, and overlook the intricate interplay of genetic, environmental, and lifestyle factors that significantly influence outcomes. These shortcomings are not just theoretical but have practical implications across various industries, including but not limited to, the development of personalized beauty products, such as skincare products.

The disclosure introduces a paradigm-shifting method and system for capitalizing on the expansive datasets generated from medical and biological research, employing a refined artificial intelligence framework designed to enhance individual well-being through personalized solutions. The disclosed system includes a sophisticated analytical engine adept at amalgamating and deciphering biologic data from genetic, environmental, and lifestyle sources to inform a diverse array of decisions spanning the healthcare and consumer product industries. The biologic data is processed using one or more neural networks, a mixture-of-expert models, or a combination of both. The neural networks and expert models are engineered to pinpoint essential biomarkers and interpret complex biologic datasets, thereby yielding actionable insights for personalized response determination. The utility of the system extends beyond the theoretical and ventures into the tangible, affecting everyday life. Take, for instance, its application in the cosmetic industry: the technology stands to redefine the approach to skincare recommendations. Through a nuanced analysis of an individual's biological makeup, in synergy with environmental and lifestyle factors, the system adeptly forecasts skin responses to a broad spectrum of products. The result can be a series of finely-tuned product recommendations, each distinctively tailored to the individual's unique biological narrative.

Additionally, the system's inherent adaptability facilitates the exploration and creation of innovative products and treatments, as it can discern latent demands and opportunities within the dataset, paving the way for potential partnerships with manufacturers to bring these new solutions to fruition. This granular, data-centric analytical process can lead to the development of new products, which can be crafted to address the identified needs through the system's advanced learning capabilities. Consequently, the description provided herein delineates a new paradigm wherein personal care and health-related decision-making are rooted in a deep, data-informed comprehension of an individual's biological, environmental, and lifestyle profiles, heralding a new era in personalized medicine and consumer products.

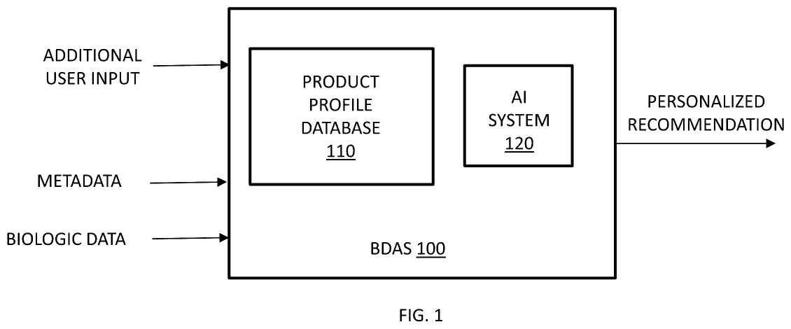

FIG. 1 illustrates a block diagram of an example of a personal recommendation system constructed according to the principles of the disclosure. The personal recommendation system, referred to as biologic data analysis system (BDAS), is a computing platform or system configured to automatically generate personalized recommendations, such as beauty product recommendations, based on a user's biologic data and corresponding metadata, as well as one or more product profile databases, such as product-ingredient profile database for skin care or other beauty care products, e.g., a beauty product database. The BDAS 100 can automatically process the different type of user related inputs, the biologic data and the metadata, into a more usable form to allow combining the different data types for generating recommendations and also for training. The biologic data includes genetic data and other types of omic data of a particular user. The metadata is additional information about the particular user, such as demographic data, personal medical history, lifestyle choices, and environmental exposure details.

The personal metadata and biologic data of a user can be manually input. For the metadata, the user can engage with the BDAS 100 through an intuitive web interface, answering a series of questions that delve beyond physical features to encompass environmental and lifestyle data. The broad spectrum of the metadata forms a comprehensive profile, allowing the BDAS 100 to generate more accurate and holistic recommendations. The BDAS 100, with its dynamic learning capabilities, can continuously refine the questions based on user interactions and emerging data trends, thus enhancing the personalization aspect of the recommendations. Additionally, user preferences, such as affinity towards specific product attributes or brands, are captured to further tailor the recommendation process.

Users have the flexibility to contribute their biologic data, which may be procured through various means, such as test kits provided for at-home sampling or data previously obtained through healthcare providers. Biosensing hardware can be used to obtain the biologic data. For example, a genomic sequencer, an imaging device, or another type of equivalent sensor typically used in the art to obtain various types of biologic data can be used. The biologic data can be uploaded to the BDAS 100 via a web interface. The biologic data can include biological sequencing data provided from biological samples. The biological samples can be provided and the sequencing information can be obtained therefrom or the user can provide their DNA sequencing data. The biologic data can also include skin microbiome data that can also be obtained from samples provided by the user or the user can provide the data. The BDAS 100 is engineered to process the biologic data, encompassing a wide spectrum of biological information from genomic sequences to proteomic and metabolic profiles. Advanced analytical algorithms within the BDAS 100 interpret the biologic data, drawing correlations between the biological markers and potential responses to a vast array of products. The comprehensive analysis enables the exclusion of items that could potentially elicit adverse reactions to a user, ensuring that the resulting recommendations are aligned with the user's unique biochemical landscape for optimal safety and efficacy.

The BDAS 100 includes one or more product profile databases, represented by product profile database 110, and an artificial intelligence (AI) system 120. The BDAS 100 can be implemented on one or more computing devices or systems that include one or more data interfaces, one or more memories, and one or more processors. As such, the functionality of the BDAS 100 can be distributed across various computing devices or computing systems. The BDAS 100 can be a cloud computing system.

Product profile database 110 includes products in a defined field and information for the products. As noted above the product profile database 110 can be for the defined field of skin care and include a list of skin care products and the ingredients of the skin care products. In another example, the product profile database 110 can be directed to medicine and drugs, such as drugs used to treat diabetes. As such, the product profile database 110 can include a list of diabetic associated drugs and the ingredients of the drugs. In addition to the products and ingredients, the product profile database 110 can include particular areas or problems that the products are designed to address, such as dry skin or insulin resistance.

The BDAS 100 can include or have access to a library of product profile databases stored in a data reservoir and select a particular one of the product profile databases for a particular application. For example, the biologic data and metadata may be directed to skincare and the product profile database 110 would be a database for skincare products. The BDAS 100 can automatically select a corresponding database based on the received user related inputs or a corresponding database can be manually selected by a user. A drop down menu can be used to select the type of product profile database.

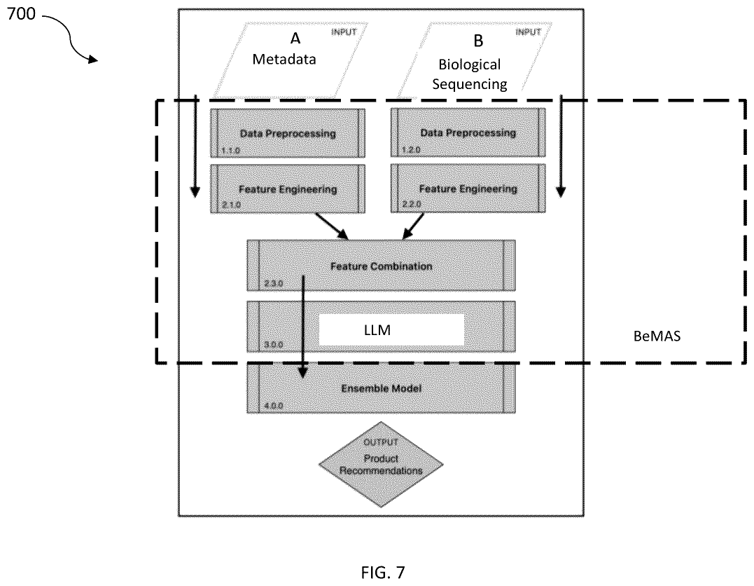

The AI system 120 is systematically adapted for the intricate task of data integration and analysis of multiple types of biologic data. In one example, the AI system 120 can be a model trained using a machine learning algorithm, such as a neural network (NN) or a deep neural network (DNN) and the trained model can be used to provide the personalized recommendation in view of the metadata, the biologic data, or both. FIG. 7 illustrates an example method of training a model.

In another example, the AI system 120 can use a large language model (LLM) to serve as the decision-making center, utilizing prompts to generate the personalized recommendation as a response. The LLM can be a Biologically Embodied Multilayer Analysis System (BeMAS) that encapsulates a ‘Mixture of Experts’ (MoE) module that incorporates a mixture of experts and learnable routers. The BeMAS is distinguished by its modular MoE design, which dynamically engages a subset of neural network parameters, specifically tailored to the analytical task at hand. The modular design can be instrumental in parsing and interpreting comprehensive datasets of biologic data that include, but are not limited to, genomic sequences, transcriptomic profiles, proteomic patterns, and metabolic pathways. The datasets are further contextualized with the metadata inputs. In operation, the BeMAS facilitates the selection of the most pertinent ‘expert’ neural networks within its framework to process specific segments of the integrated biologic data, thereby enhancing computational efficiency and preserving the fidelity of the analytical outputs. This methodology affords a meticulous level of data interrogation, pivotal for the derivation of individualized recommendations across a broad spectrum of applications, encompassing but not limited to the personalization of cosmetic selections, the tailoring of health and wellness guidance, the customization of nutritional plans, the adaptation of fitness programs, the specificity of therapeutic interventions, and the personal calibration of lifestyle choices.

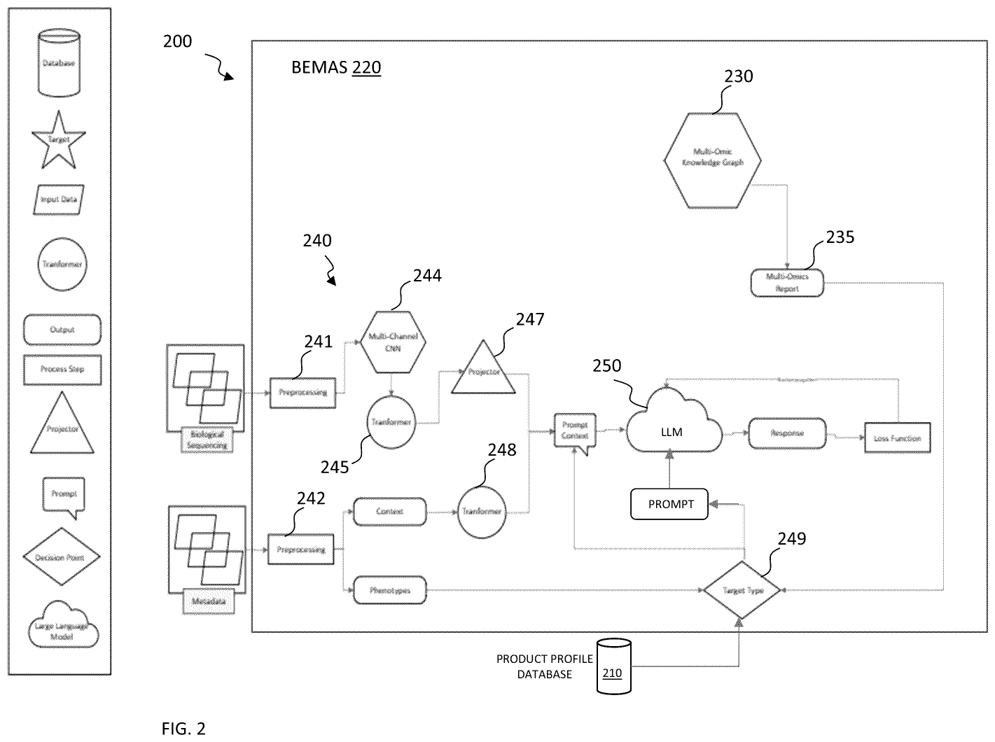

The BeMAS collectively contributes to a robust system for personalized assessment, departing from generic analysis approaches. By utilizing the selective parameter engagement strategy of the BeMAS model, the BDAS 100 can achieve optimized processing speeds and reduced computational load, without compromising the accuracy or depth of data analysis—thereby representing a significant advancement over existing analytical tools and systems. The system's personalized recommendations are informed by an understanding of an individual's unique biological profile, offering a bespoke user experience and embodying the forefront of personalized health and wellness technology. FIG. 2 provides additional detail of an example of BDAS 100 having a BeMAS.

FIG. 2 illustrates a block diagram of an example of BDAS 200 configured to autonomously generate personalized recommendations according to the principles of the disclosure. BDAS 200 includes a product profile database 210 and a BeMAS 220. The product profile database 210 corresponds to the product profile database 110 of FIG. 1 and represents multiple product profile databases that can stored in a data reservoir. FIG. 2 illustrates the architecture representing the interaction of BeMAS 220; including the interaction with the product profile database 210. The BeMAS 220 is adept at processing a confluence of multi-layered inputs to produce customized suggestions, with applications ranging from skincare to a broad array of personalized products and treatments.

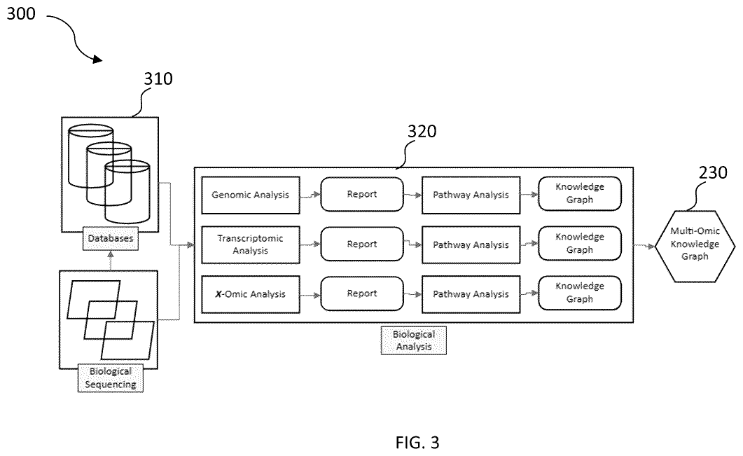

The BeMAS 220 includes a multi-omic knowledge graph 230 that encapsulates a holistic view of an individual's biological landscape. The multi-omic knowledge graph 230 is generated from biologic datasets and biological sequencing data. FIG. 3 illustrates an example of generating the multi-omic knowledge graph 230. A ‘Multi-Omic Report’ 235 is provided from the multi-omic knowledge graph 230 in a format that can be used for prompts or prompt context for LLM 250.

BeMAS 220 receives biologic data and metadata as inputs. In FIG. 2, the biologic data is represented by biological sequencing data. Other examples of biologic data, such as skin microbiome data can be used instead of or in addition to the biological sequencing data. The biological sequencing data and metadata can be received as described with respect to FIG. 1. BeMAS 220 includes one or more processors, generally denoted by element number 240, that process the received biological sequencing data and metadata. Both the biological sequencing data and the metadata are preprocessed as denoted by processing blocks 241, and 242. The preprocessing synchronizes the metadata with the biological sequencing data. The metadata and the biological sequencing data can be concurrently processed. The preprocessing advantageously integrates the nuances of the biological sequencing data with the corresponding contextual metadata, including phenotypic information—the observable traits of an organism in question.

After preprocessing, the biological sequencing data is further processed to identify and interpret the elaborate interdependencies within the biological sequencing data. A multi-channel CNN 244, that has been trained using the multi-omic knowledge graph 230, receives the biological sequencing data and generates multi-omic heatmaps representing the biological sequencing data. Essentially the multi-omic knowledge graph 230 tells the multi-channel CNN 244 what to look for in the biological sequencing data. For example, the multi-omic heatmap can represent correlations between the omic data, such as genomic and/or transcriptomic, and the biologic data, such as biological sequencing data and/or skin microbiome data. The multi-channel 244 employs a variety of convolutional filters to extract salient features and patterns, indicative of distinct biological states or conditions. Enhancing the classification phase, a multilayer perceptron refines the capability to classify a spectrum of biological states and pathogenic possibilities with heightened accuracy and nuance.

The heatmaps generated by the multi-channel CNN 244 are provided to transformer 245 that is configured to cooperate with projector 247 to transform the image of the heat map into a format that is understood by LLM 250. The transformer 245 transforms the heat map image to a vector format and the projector 247 modifies the resulting vectors to match the vectors provided by transformer 248 from the metadata. A prompt context is then generated for querying the LLM 250. As such, the information of the heat map and the metadata is embedded into the language of the prompt context that can then be used for prompting the LLM 250. The prompt context, therefore, primes the LLM 250, with information from the multi-omic knowledge graph 230, and the personal information of a user from their biologic data represented by their biological sequencing data, and their metadata, to provide responses to queries.

As noted above, BeMAS 220 can concurrently process the metadata with the biological sequencing data. The preprocessing of block 242 separates the metadata into context and phenotypes. Transformer 248 transforms to context information into a vector format that can be used for the prompt context.

LLM 250 provides a response (the personalized recommendation) to a prompt in view of the prompt context. LLM 250 can be a biologically embodied LLM that is configured to relate biologic data and metadata. LLM 250 can also relate the biologic data and physical data with products through the product profile database 210. Accordingly, the LLM 250 can be MoE dedicated to biologic data, metadata, and products.

The prompt and the resulting response correspond to a target type that can be determined by the one or more processors denoted by decision point 249 in FIG. 2. The target type can be automatically selected by BeMAS 220. The other target types of BeMAS 220 are provided to the prompt context. For example, if the target type is products then the two other target types upon which BeMAS 220 has been trained, such as phenotypes and the multi-omic report 235, are used as context and the product target type will go into the prompt. A user can also select a target type and query the LLM 250 to obtain different responses via inputting additional information such as illustrated in FIG. 1.

The response is an analytical output from LLM 250 that is assessed against a ‘Target,’ which symbolizes a set of predefined benchmarks or outcomes, such as the precise characterization of a disease state based on a comprehensive profile represented by the multi-omic knowledge graph 230. A ‘Loss Function’ is employed to appraise the success of the response in meeting the ‘Target,’ thereby providing a quantifiable measure of the prediction accuracy of the LLM 250. The learning process of LLM 250, manifested through ‘Backpropagation,’ ensures the continual refinement of the analytical model.

The knowledge gained through the learning process can be used to modify/generate the multi-omic knowledge graph 230 by incrementally refining parameters to amplify the predictive precision. The culmination of this iterative learning process is manifested in the generation of the encompassing multi-omic report 235 that distills the essence of the integrated biological and metadata analysis into a coherent narrative, presenting tailored insights congruent with the unique biological and contextual narrative of the individual or the biological condition in question.

FIG. 3 illustrates an example of a pipeline 300 is used to generate the multi-omic knowledge graph 230 of FIG. 2. The pipeline 300 includes a data reservoir 310 and a biological analyzer 320. The pipeline 300 is a comprehensive multi-omic analysis pipeline that is architected to process a diverse array of biologic data sourced from the data reservoir 310.

The data reservoir 310 includes biologic datasets from omic databases that are from medical and biological research. The omic databases can be from publically available research, private research, or a combination of both. The omic databases serve as foundational repositories housing not only genomic and transcriptomic data but also including a broad spectrum of additional biologic datasets, represented collectively as x-omic data. The x-omic data includes additional omic data for analyses pertinent to the multifaceted modeling requirements of a BDAS as disclosed herein. The omic data, which includes the genomic, transcriptomic, and x-omic data types, collectively serve as the foundation for in-depth biological analysis by the biological analyzer 320.

The biological analyzer 320 is one or more processors configured to generate the multi-omic knowledge graph 230 from the omic data and biological sequencing data. The biological sequencing data can be publically available data that is obtained and used for training in addition to the biologic data from the data reservoir 310. The biological analyzer 320 receives the biological sequencing data and the omic data from the data reservoir 310 and separates the received data for type-specific analyses, ‘Genomic Analysis,’ ‘Transcriptomic Analysis,’ and ‘X-Omic Analysis’, for sequential investigation of each type of the omic data, yielding comprehensive reports that provide a detailed account of each specific analysis. These reports are subjected to ‘Pathway Analysis’ to uncover biological functions embedded within the omic data. In the Pathway Analysis, the functional implications of the omic data are elucidated, elucidating the biological pathways and molecular interactions. The insights from these pathways are then abstracted into individual ‘Knowledge Graphs,’ which provide a schematic representation of the interconnected biological processes as revealed by the specific omic data analysis. Insights from the Functional Analysis is organized and integrated into ‘Knowledge Graphs,’ which visually map the complex biological interactions.

The biological analyzer 320 can use biological processing tools that are known and used in the industry to execute the type-specific analysis to generate the knowledge graphs. The biological analyzer 320 can then converge the resulting knowledge graphs into a single format to form the multi-omic knowledge graph 230, encapsulating a holistic view of an individual's biological landscape.

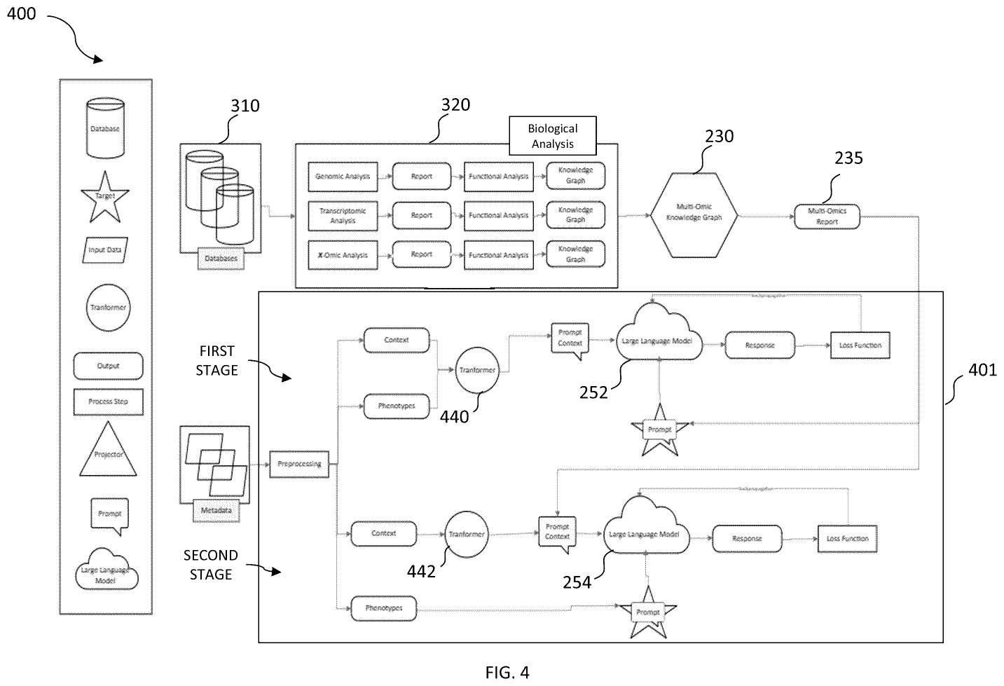

FIG. 4 portrays an example of a training process or regimen 400 for BeMAS 220 encapsulating a ‘Mixture of Experts’ module. Regimen 400 involves the initial education of multiple large language models, each tailored to specialize in disparate tasks of biological processing and analysis. These distinct models, henceforth designated as ‘Experts,’ are meticulously configured to master various complex domains inherent to biologic data interpretation.

Upon the completion of this dedicated training phase, the resultant model weights are meticulously transferred into an aggregate assembly of experts. This collective is then housed within a comprehensive language model architecture, which boasts the capability to discern and elect the most suitable ‘Expert’ contingent upon the specific analytical task being executed. This discernment is facilitated by the system's inbuilt algorithmic proficiency in evaluating the demands of the task and selecting the optimal ‘Expert’ to deliver the most accurate insights. The two experts outlined in the training diagram of regimen 400 shows experts trained by the ‘Biological Analysis Pipeline’ 300 (LLM 252) and ‘Metadata’ (LLM 254). An additional expert can also be similarly trained using products. The resulting expert LLMs, LLM 252, LLM 254, and the product trained LLM, would provide LLM 250.

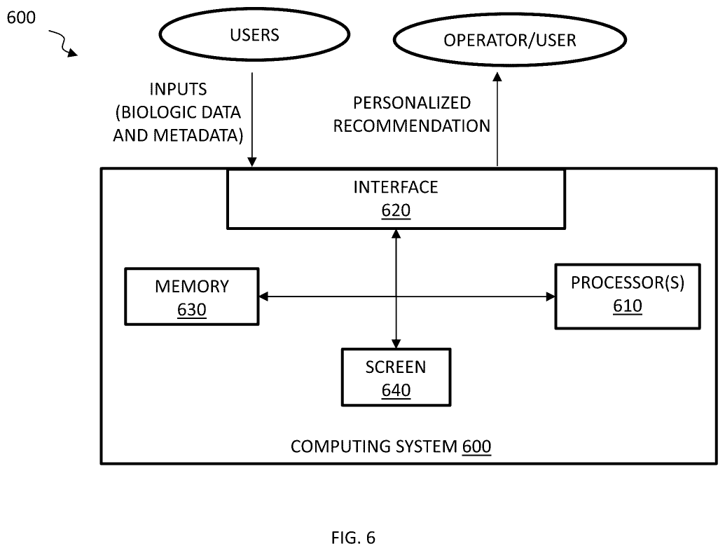

Regimen 400 illustrates training in different stages; specifically two in FIG. 4. One or more computing devices or systems, such as servers, can be used for the training according to the different stages. A computing system having an interface, data storage (e.g. memory) and one or more processors, such as shown in FIG. 6, is an example of a computing system that can be configured with the necessary circuitry, logic, etc. for performing the training. A training server 401 indicated in FIG. 4 provides an example. More than one training server can be used, such as different training servers for different stages. In one stage (for LLM 252) phenotypes are used as context and the intent is to train the LLM 252 to output a response that corresponds to the multi omic report 235.

In the second stage (for LLM 254) the multi omic report 235 is used as context and the LLM 254 is trained to provide a response of phenotypes. The two models LLM 252 and 254 from the two different stages of training are formed into a mixture of experts that can be used as shown in FIG. 2. The individual stages of training allows generating a response when all of the inputs are not used or are not available. For example, if a user only has metadata, a multi-omic report can be generated that training was done in different stages with context. The transformers 440, 442, can operate similar to transformer 248 of FIG. 2.

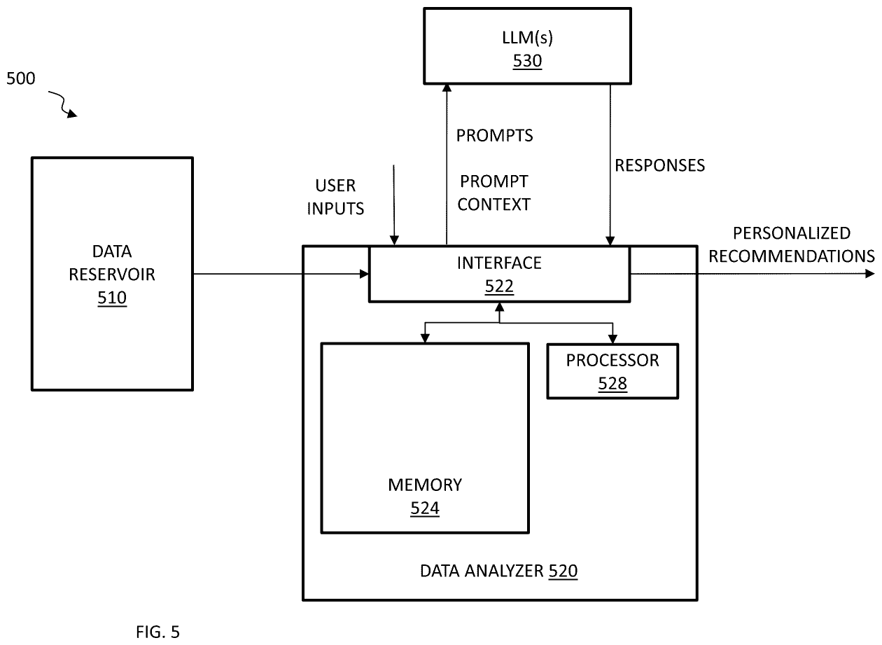

FIG. 5 illustrates a block diagram of an example of a BDAS 500 constructed according to the principles of the disclosure. The BDAS 500 is a computing system that includes a data reservoir 510 and a data analyzer 520. The data reservoir 510 and the data analyzer 520 can be located proximate each other or remotely located from each other. Regardless, the data reservoir 510 and the data analyzer 520 can be communicatively coupled together via a conventional connection.

The data reservoir 510 is data storage that is configured to store data to be used by the data analyzer 520. The data reservoir 510 can be one or more memories or data storage devices. The data reservoir 510 can be implemented in a data center.

The stored data can be used for training of one or more LLMs, inferencing by one or more LLMs, or for both. The one or more LLMs can be expert LLMs. The LLMs are represented by LLM 530 in FIG. 5. The data can be biologic data, such as genomic and omic data stored on data reservoir 310 of FIG. 3, or biological sequencing data that has been stored for a particular user or collected for training from multiple individuals. Metadata for a user or general metadata for training can also be uploaded to the BDAS 500 and stored in the data reservoir 510. The data can also be product data, such as from product profile database 110. The data reservoir 510 can receive and store the data via an upload or via another conventional means.

The data analyzer 520 cooperates with LLM 530 to provide personalized recommendations. LLM 530 can be on-line or offline. LLM 530 can be LLM 250 of BeMAS 220. Data analyzer 520 is configured to generate prompts and prompt context for the LLM 530.

The data analyzer 520 includes one or more interfaces represented by interface 522, one or more memories represented by memory 524, and one or more processors represented by processor 528. The interface 522 is a communication interface that receives the data from the data reservoir 510 and provides to the processor 528 for processing, analysis, and generation of the prompts and prompt context. The interface 522 includes the necessary circuitry, software, or combination thereof to send and receive data. The interface 522 can be a conventional interface. The interface 522 can include a user interface, such as a keyboard, keypad, touchscreen, speaker, etc. to receive additional user inputs and/or provide the personalized recommendations from the responses.

The memory 524 can store data and operating instructions that direct the operation of the processor 528. The memory 524 can include the necessary circuitry for storing data and the processor 528 can include the necessary computing circuitry for processing data. The operating instructions can be or can represent one or more algorithms directed to the processes of FIGS. 2-4. For example, processor 528 can correspond to the one or more processors 240 in FIG. 2, as represented by element numbers 241, 242, 244, 245, 247, 248, and 249, which are used to generate prompts and prompt context for the LLM 250. The algorithms can also direct the generation of the multi-omic knowledge graph 230. The data analyzer 520 and the LLM 530 can form a BeMAS, such as BeMAS 220.

FIG. 6 illustrates a block diagram of another example of a BDAS 600 constructed according to the principles of the disclosure. The BDAS 600 can be a server or a combination of servers. The BDAS 600 can be one or more computing device that is part of a computing platform, such as a cloud computing platform. The BDAS 600 includes the logic for carrying out at least some of the methods and processes as disclosed herein for generating personalized recommendations based on, for example, a combination of two or more of biologic data, metadata, and a product profile database. A combination of all three can be used to provide the personal recommendations. In addition, the BDAS 600 can provide a virtual consultation professional, such as with beauty professionals. The BDAS 600 can be integrated with e-commerce platforms, allowing users to purchase recommended products directly.

The BDAS 600 includes one or more processors represented by processor 610, a communications interface 620, one or more memory represented by memory 630, and a screen 640. The processor 610 can perform operations as disclosed herein and represented by the various flow diagrams in the figures. The processor 610 can be directed by a series of operating instructions that correspond to one or more algorithms for generating personalized recommendations. The processor 610 can include one or more NNs. The series of operating instructions can be stored on the memory 630. The memory 630 can be a non-transitory computer readable medium. A product profile database can also be stored on the memory 630.

The interface 620 is configured to transmit and receive data, and can include the necessary circuitry, logic, etc. for performing these functions for various protocols. The processor 610 uses personal inputs to generate personalized recommendations. The screen 640 can be used as a user interface for operating the BDAS 600 and for providing a questionnaire for receiving biologic data and metadata. A user device, such as a smartphone, can be used by the user to provide the inputs. Various biological sensors can be used to obtain the biologic data. There can be more than one of each of the components of the BDAS 600 and all of the components can be connected via connections typically used in the industry. The BDAS 600 can include additional components not included herein but typically used in the industry. For example, the BDAS 600 can include one or more user interfaces, such as a keyboard, mouse, etc. The BDAS 600 can be used to provide personalized recommendations, such as those noted herein, according to the type of inputs received, the type of product profile database, and/or the type of biologic data. The training and models used can also vary depending on the type of personalized recommendations that are desired. For example, the BDAS 600 can provide personalized recommendations to individuals for beauty products.

The methodology 700, as illustrated in FIG. 7, is an embodiment of the disclosed system that adeptly creates personalized product recommendations. The method 700 can be directed towards beauty products as noted herein, and can be used for personalization within various other domains, like dietary planning, fitness regimes, or even more nuanced medical treatments. The fluidity of the process allows for steps to be adapted or reordered to suit specific applications, culminating in a tailored set of recommendations. Importantly, methodology 700 is designed to be iterative, enabling users to refine their inputs—whether it be updated omic data or changing environmental factors—to iteratively hone the results. The various features of methodology 700 are discussed below with reference to the letters and numbers shown in FIG. 7. As shown in FIG. 7, a BeMAS may be used, such as, for example, BeMAS 200.

A. Physical and Environmental Characteristics Profiling: Users engage with the system through an intuitive web interface, answering a series of questions that delve beyond physical features to encompass environmental and lifestyle data. This broader spectrum of data forms a comprehensive profile, allowing the AI within the computing system to generate more accurate and holistic recommendations. The AI system, with its dynamic learning capabilities, continuously refines the questions based on user interactions and emerging data trends, thus enhancing the personalization aspect of the recommendations. Additionally, user preferences, such as affinity towards specific product attributes or brands, are captured to further tailor the recommendation process.

B. Multi-Omic Profile Construction: Users have the flexibility to contribute their omic data, which may be procured through various means, such as test kits provided for at-home sampling or data previously obtained through healthcare providers. The system is engineered to process this omic data, encompassing a wide spectrum of biological information from genomic sequences to proteomic and metabolomic profiles. Advanced analytical algorithms within the system interpret this data, drawing correlations between the biological markers and potential responses to a vast array of products. This comprehensive analysis enables the exclusion of items that could potentially elicit adverse reactions, ensuring that the resulting recommendations are aligned with the user's unique biochemical landscape for optimal safety and efficacy.

Step 1: Multi-Omic Data Preprocessing—The preprocessing encompasses harmonizing heterogeneous data types, aligning them for integration. This process is critical for combining diverse omic datasets, which might include genomic, proteomic, metabolomic, and other omic forms, ensuring that subsequent analysis can leverage the full scope of collected information.

1.1.0. Preprocessing of Multi-Omic Data: The subsequent steps 1.1.1. to 1.1.4. detail the preprocessing phases specifically tailored for multi-omic data:

1.1.1. Data Cleaning: The process begins with the elimination of redundancies and correction of errors within the datasets. This involves filtering out duplicate entries, rectifying inconsistencies, and validating data against known biological parameters to ensure accuracy.

1.1.2. Missing Data Handling: In instances of incomplete data, various strategies are employed to construct a coherent dataset. Missing values may be imputed using statistical methods such as mean or median values, or through more complex procedures like k-NN imputation, which infers missing information based on the similarity to other data points.

1.1.3. Encoding: Categorical data, such as descriptors of omic profiles or environmental factors, undergo encoding to translate them into a numerical format suitable for computational analysis, often employing methods like one-hot encoding.

1.1.4. Normalization and Scaling: Quantitative omic data is standardized to ensure uniformity in scale across various data types, facilitating comparison and pattern recognition by the system's algorithms.

1.2.0. Advanced Omic Data Preprocessing: This stage addresses the specific needs of complex omic datasets, preparing them for integration into the multi-omic profile:

1.2.1. Data Quality Assurance: Data integrity checks are conducted, examining the quality of omic sequences and removing any elements that do not meet the stringent criteria for analysis.

1.2.2. Comprehensive Data Completion: Data augmentation techniques may be applied, generating synthetic data points where necessary to provide a full representation of the omic landscape, ensuring that the analysis encompasses a complete biological picture.

1.2.3. Feature Representation: The system converts omic data into an analytically robust format, leveraging various representation techniques to encapsulate the essential information within the data, such as one-hot encoding or k-mer frequency analysis.

### Step 2: Feature Engineering for Multi-Omic Data

2.1.0. Feature Engineering from Omic and Metadata: The system advances into a detailed feature engineering process, transforming both omic data and metadata into meaningful attributes that enhance the model's predictive power.

2.1.1. Feature Selection: A meticulous selection process identifies salient features within the multi-omic data that have a significant impact on outcomes. These may encompass not just physical attributes but also environmental factors and personal habits that contribute to the overall biological profile.

2.1.2. Feature Creation: Going beyond mere selection, the system innovates by synthesizing new features from existing data. It may, for example, derive interaction terms or compute complex transformations that encapsulate interactions between different omic data types and metadata, enriching the input for subsequent analytical models.

2.2.0. Omic Data Feature Engineering: This step refines the preprocessed omic data, bolstering the dataset with features that are tailored for deep learning algorithms.

2.2.1. Feature Representation: Using advanced computational methods, the omic data is restructured into representations that embody the intricate nature of the biological information, preparing it for the nuanced analysis that follows.

2.2.2. Implementation of Deep Learning Techniques: The system employs sophisticated deep learning techniques to extract and learn high-level features from the omic data. This may involve utilizing autoencoders to detect data patterns or neural networks to capture and interpret complex biological signals.

2.2.3. Dimensionality Reduction: In cases where the feature set is particularly rich and complex, dimensionality reduction techniques are applied. Methods like PCA, t-SNE, or UMAP distill the data into its most informative components, maintaining the integrity of the biological signals while simplifying the model's interpretive tasks.

The concurrent engineering of features from omic data and metadata ensures a harmonious integration, setting the stage for a robust combined analysis. This process lays the groundwork for the system to discern with greater acuity the nuanced interplay between diverse biological markers and environmental influences.

Upon completing feature engineering, the system progresses to amalgamating these features into a consolidated matrix that encapsulates the multidimensional nature of the user's profile.

2.3.1. Combined Feature Matrix Construction: Here, the disparate feature sets are unified into a singular matrix, which becomes the foundational input for the machine learning models that will generate personalized recommendations.

2.3.2. Optimization for Machine Learning: The combined feature matrix is then meticulously optimized, scaled, and encoded to align with the requirements of the advanced machine learning algorithms, ensuring the data is primed for the most effective analysis possible.

### Step 3: AI-Enhanced Analytical Models, Utilizing Neural Network Architectures to Interpret the Intricate Web of Multi-Omic and Metadata Features for Precise Recommendations.

3.1.0. Integrative Analysis with Neural Networks: This step involves employing neural networks that synthesize insights from both omic data and user interactions, moving beyond traditional collaborative filtering.

3.1.1. Neural Network Models for Pattern Recognition: System 100 incorporates neural networks using techniques like matrix factorization, embedding layers, and dense networks, which are adept at discerning complex, non-linear patterns within the multi-omic data, embodying a more nuanced form of collaborative filtering.

3.1.2. Model Training with Multi-Omic Data: The neural network is trained on a dataset that combines user interactions with omic-based product profiles, refining the model's capacity to predict user preferences and product suitability with high precision.

3.2.0. Contextual Analysis with Neural Networks: The technology delves into contextual analysis by harnessing the power of neural networks, which use the compiled feature matrix to discern individual user needs and product attributes.

3.2.1. Neural Network Configuration for Personalized Recommendations: A specifically designed neural network takes the comprehensive feature matrix as input, which includes both multi-omic data and metadata, to determine the context of each recommendation.

3.2.2. Deep Learning for Predictive Accuracy: The model integrates deep learning techniques, utilizing layers that are fine-tuned to process the dense multi-omic information, ensuring robust predictions of product fit.

3.2.3. Iterative Model Refinement: This neural network is iteratively trained and validated using rich datasets that capture the multifaceted nature of user preferences and omic profiles.

3.3.0. Synthesis of Analytical Models: Reflecting the interconnected nature of the system as depicted in the overview diagram, this step synthesizes the outputs from multiple neural network models to form a composite analytical framework.

3.3.1. Fusion of Neural Network Insights: A dedicated neural network harmonizes the insights derived from the multi-omic feature matrix, enhancing the prediction strength through an integrated analysis.

3.3.2. Comprehensive Model Training and Validation: The hybrid neural network undergoes rigorous training and validation, corroborating its efficacy across various datasets and ensuring that the recommendations it provides are not only personalized but also extensively vetted for accuracy and relevance.

### Step 4: Fusion of Insights Through Ensemble Neural Networks

4.1.0. Input Layer Configuration: The ensemble model commences with an input layer ingeniously crafted to amalgamate the predictive insights from the preceding neural networks. This pivotal layer weaves together the diverse outputs, whether through embedding concatenation or intricate merging within subsequent layers, setting the stage for a harmonious fusion of analytical depth.

4.1.1. Integration of Multidimensional Outputs: The input layer stands as a testament to the system's integrative capability, seamlessly uniting the nuanced outputs derived from various neural network models, embodying a convergence of insights that are the essence of personalization.

4.2.0. Architectural Synthesis in Hidden Layers: Moving deeper, the hidden layers of the ensemble model represent an experimental ground where different architectures are melded, with an array of layer configurations being tested and tuned to achieve an optimal balance of precision and complexity.

4.2.1. Exploratory Design of Neural Architectures: These layers form a tapestry of computational potential, utilizing an assortment of techniques such as dense connections, dropout for robustness, and batch normalization for stability, thereby crafting a neural network that epitomizes adaptability and learning efficiency.

4.3.0. Hyperparameter Optimization: In pursuit of excellence, the ensemble model undergoes an extensive hyperparameter optimization process, meticulously calibrated to refine the network's capabilities to interpret the rich multi-omic data and metadata.

4.3.1. Tailoring Network Dynamics: Through empirical exploration, the model is finely tuned across dimensions such as the architecture's depth, neuron distribution, activation dynamics, and learning momentum, ensuring each parameter contributes to the ensemble's potency.

4.3.2. Precision-Driven Hyperparameter Selection: Advanced techniques such as grid search, random search, and Bayesian optimization are deployed in the quest for the ensemble model's ideal configuration, demonstrating the system's commitment to data-driven excellence.

4.4.0. Rigorous Training and Validation Regime: The ensemble model is subjected to a rigorous training and validation regimen, utilizing a comprehensive dataset reflective of real-world interactions and preferences.

4.4.1. Empirical Model Refinement: Throughout training, the ensemble is meticulously honed, employing user-item interaction data to refine its predictive prowess, with a keen eye on performance metrics that ensure reliability and user satisfaction.

4.4.2. Advanced Optimization Algorithms: Utilizing state-of-the-art optimization algorithms, the model's performance is enhanced, minimizing the loss function and ascending the gradient of accuracy to new heights.

4.4.3. Optimization Strategies for Model Integrity: In the ensemble model's training regimen, advanced techniques such as early stopping are integrated to preempt overfitting, enhancing the model's generalization capabilities. Additionally, learning rate scheduling is carefully implemented, optimizing the training trajectory and ensuring the model's performance is calibrated for peak efficiency.

4.5.0. Rigorous Ensemble Model Evaluation: The ensemble model undergoes a thorough evaluation phase, deploying a comprehensive array of performance metrics. These evaluations are crucial to affirm the model's precision, recall, F1 score, and overall accuracy, ensuring its outputs are both reliable and beneficia

4.5.1. Comparative Performance Assessment: Benchmarking the ensemble model against its component neural networks provides a clear comparative analysis. This step validates that the ensemble approach indeed leverages the combined strengths of its constituent parts to deliver enhanced recommendations

4.5.2. Validation Through Cross-Validation: Employing validation strategies like k-fold cross-validation offers a robust measure of the ensemble model's performance on unseen data, confirming the model's resilience and reliability.

Delivery of Tailored Recommendations: The culmination of Method 300 is the provision of personalized recommendations, each underpinned by a detailed rationale derived from the user's omic data and metadata. This comprehensive output not only suggests suitable products but also educates the user on the reasons behind each recommendation, enhancing their understanding and engagement with the system.

Enhancing Recommendation Efficacy: The system continuously improves through the analysis of user interaction data, informing not only the refinement of recommendations but also providing valuable insights for market research and product development. This data-driven feedback cycle is crucial for evolving the system's capabilities and can be leveraged for targeted marketing and advertising efforts.

Incorporating genome-wide association studies (GWAS) and User Feedback for Continuous Learning: The algorithm's refinement is an ongoing process, bolstered by insights from GWAS that illuminate genetic markers influencing skin and hair phenotypes. Coupled with user feedback, these data points are instrumental in enhancing the system's predictive accuracy. By incorporating this information into the algorithm, further improvements can be made to the accuracy of the product recommendations for the user.

User Experience as a Feedback Mechanism: Active analysis of user feedback serves to elucidate product effectiveness and inform algorithmic adjustments. By understanding user experiences in various contexts, the system identifies trends and adapts, ensuring the recommendations remain attuned to user needs and preferences. For example, user feedback can help understand which products were effective and which ones were not, as well as other factors that may have contributed to the user's experience, such as environmental factors or changes in skin or hair care routines. By analyzing this feedback, trends can be identified and the algorithm can be adjusted accordingly, to better meet the needs of the users. Overall, by combining the power of GWAS with user feedback, continuous refinement and optimization of the algorithm can be obtained, improving the accuracy and effectiveness of the product recommendations.

User Interface and Predictive Analysis Symbiosis: Method 700 can manifest through an interactive web interface where users can provide their omic data, either directly uploaded or derived from home test kits. The backend analytical system processes this information through a multi-omic analysis pipeline, outputting personalized recommendations. The feedback loop closes as user responses feed back into the system, continually refining the accuracy and personal relevance of the recommendations. This user-centric approach ensures the system evolves in alignment with real-world efficacy and user satisfaction.

As noted above one example for the product recommendation algorithm involves a web interface that allows users to fill out a questionnaire about their skin's physical features and upload their genotyping data. The algorithm then uses a machine learning genotyping pipeline to analyze this information and generate personalized skin care product recommendations. The physical and genotypic profiles are used in combination with the product-ingredient profile database to select appropriate products that meet the user's specific needs. The feedback from users about the products they've used is used to improve the algorithm and provide more accurate recommendations.

An alternate design for this invention could involve a mobile application (or simply app) that users can download and use to fill out the questionnaire and upload their genotyping data. The app could then use machine learning models to generate personalized product recommendations based on the user's physical and genotypic profiles. This design would provide a more user-friendly and accessible way for people to get personalized skin care product recommendations. The mobile app could be used on a mobile computing device, such as a smartphone, a computing pad, a computing tablet, or another mobile computing device. The mobile computing device can include a camera that obtains a photograph or video of the user that can also be used as an input along with the questionnaire.

The product recommendation algorithm utilizes machine learning models to generate personalized recommendations, such as for skincare product recommendations. For skincare, the algorithm can employ two models: the physical skin-care model and the genotypic skin-care model.

### Physical Skin-Care Model:

In operation, the physical skin-care model processes the following inputs:

a. Physical profile: Created from the user's responses to a questionnaire about their skin's physical features such as skin type, concerns, and preferences.

b. Product-ingredient profile database: Contains information about skincare products, their ingredients, and their intended applications.

The model applies correlation matrices and machine learning techniques to match the user's specific physical characteristics with appropriate skincare products. The output is a prioritized list of products tailored to the user's physical features that will help address their specific skincare needs.

### Genotypic Skin-Care Model:

In operation, the genotypic skin-care model processes the following inputs:

a. Genomic profile: Consists of the user's DNA sequence data, which is uploaded by the user.

b. Physical profile: As mentioned above.

c. Product-ingredient profile database: As mentioned above.

The genomic profile is analyzed to identify any single nucleotide polymorphisms (SNPs) associated with adverse ingredient reactions, allowing the algorithm to filter out any products that may cause an allergic or adverse reaction. The model then integrates the physical profile and product-ingredient profile database, along with the filtered genomic profile, to identify and rank skincare products that meet the user's specific needs without triggering adverse reactions. The output of this model is a prioritized list of products that are safe and effective for the user based on their physical and genomic profiles.

Both models employ the product-ingredient profile database, which is continuously updated with new products and ingredients as they enter the market. The database is used to create product-ingredient profiles for each product, which allow the algorithm to match the user's specific needs with appropriate products.

By utilizing these machine learning models in a complementary manner, the algorithm can provide personalized skincare product recommendations based on the user's physical and genomic profiles, resulting in more effective and safe skincare solutions tailored to individual requirements.

The disclosed algorithm uses a combination of user physical profiles, omic data, and product-ingredient profiles to tailor skincare product recommendations. Earlier attempts have primarily focused on analyzing genetic data to determine the individual's skin type and predict their response to various cosmetic materials. The approach not only incorporates genetic information but also includes user-provided physical characteristics and a comprehensive product-ingredient profile database, resulting in a more holistic and accurate recommendation system. Additionally, the algorithm employs machine learning algorithms to improve the accuracy and effectiveness of its product recommendations over time based on user feedback, which represents a more advanced approach in the industry.

The disclosed invention provides several commercial advantages, including:

a. Personalization: The algorithm tailors its product recommendations to each user's unique physical and genotypic profile. This level of personalization offers a more effective solution for the user's skincare needs, leading to increased user satisfaction, loyalty, and word-of-mouth marketing.

b. Improved Efficiency: The algorithm can process large amounts of data quickly and provide accurate product recommendations. This enhanced efficiency allows users to quickly find the best products for their needs, leading to increased sales, customer retention, and potentially reduced inventory costs.

c. Cost Savings: The algorithm's ability to accurately match products to user needs can reduce the number of product returns, saving the company money in restocking and shipping fees. Additionally, personalized recommendations can help reduce marketing costs, as users are more likely to purchase products tailored to their needs.

d. Competitive Advantage: The disclosed invention provides a unique and innovative solution for the skincare industry, setting the company apart from competitors that rely solely on genetic data or physical characteristics. This competitive advantage can help attract new customers, increase market share, and potentially establish the company as a thought leader in the personalized skincare space.

c. User Data Collection: The algorithm collects valuable user data, including physical and genotypic profiles, product preferences, and feedback. This data can be used to refine the algorithm, develop new products that better meet user needs, and inform targeted marketing campaigns. Furthermore, the user data can be used for market research, helping the company better understand its target audience, identify trends in the skincare industry, and anticipate future consumer demands.

In addition to beauty products, such as skin care, the disclosed algorithms can be applied to a wide range of personalized product recommendations based on individual genetic or physical profiles. For example, it could be used for personalized recommendations for dietary supplements, fitness plans, or even customized medical treatments.

The disclosure addresses the need for a more advanced, integrated approach to omic data analysis capable of unlocking personalized insights at an unprecedented scale. There exists, therefore, a significant opportunity to innovate and develop a technology that not only tackles these analytical challenges but also paves the way for applications that can transform personal healthcare, consumer products, and beyond. A solution that is versatile, robust, and capable of integrating multi-omic data with extensive metadata—ranging from demographics to environmental exposures—promises to usher in a new era of personalized solutions, tailored to the unique needs of individuals. This innovation stands to redefine how we approach the analysis and application of biologic data, making it possible to move beyond one-size-fits-all solutions towards a future where decisions, be they medical treatments or skincare regimens, are informed by deep, data-driven insights.

The disclosure provides customers with an evidence-based, unbiased, and personalized service for recommending products, such as skincare products. The disclosed systems and methods can advantageously use the vast amount of data generated through medical research by applying the data to improve everyday life aspects, such as shopping for commercial products and recommending products by integrating genomic data. The products can be skincare products that are recommended. To achieve this, the disclosed system utilizes an individual's genetic information, which is processed through a neural network to identify specific biomarkers affecting their skin's response to various products. By filtering through a great number of current commercial products on the market from one or more different manufacturers, the disclosed system provides the individual with customized recommendations based on their unique genetic makeup. More than one product can be recommended and a combination of products can be recommended. Instead of or in addition to existing products, a new product or products can be recommended and subsequently created. A personalized beauty product recommendation can be aggregated with personalized recommendations of other users and used to develop a new product. One or more different manufacturers can be recommended for creating the new product. The new product can then be added to a products list for subsequent use.

In one example, the personal recommendation system and method is a cosmetic product recommendation system and method that uses a machine learning genotyping pipeline.

The method and system generate personalized skin care product recommendations based on a user's physical and genotypic profiles, as well as a product-ingredient profile database. A computing system is disclosed that includes a web interface that allows users to fill out a questionnaire about their skin's physical features and upload their genotyping data, which is then analyzed by a machine learning model. The product-ingredient profile database contains information about various skin care products and their ingredients, which are used to generate personalized recommendations. The product-ingredient profile database is used to match user needs and filter out products that may cause adverse reactions. The structure of the system involves a machine learning pipeline that analyzes user data and generates personalized recommendations based on product-ingredient profiles. The pipeline includes modules for processing physical and genotypic data, as well as correlation matrices for selecting appropriate products. The output of the algorithm is a list of recommended products that meet the user's specific needs and are safe for them to use. The algorithm is continuously updated and improved based on feedback from users and genome-wide association studies.

Genotyping data is used to create a genotypic profile, which identifies SNPs associated with adverse ingredient reactions, and filters out any products that might cause an allergic or adverse reaction from the recommendation list. Additionally, the algorithm uses feedback from users about the products they have used to conduct genome-wide association studies, which identify product-ingredient interactions with specific genotypic markers. This ongoing improvement process ensures that the recommendation algorithm is continually refined, resulting in even more accurate and effective product recommendations.

In addition to beauty products, such as skin care, cosmetics, and hair products, the disclosed system and method can be configured to provide other personalized recommendations. For example, the personalized recommendations can be for dietary supplements, fitness plans, or even customized medical treatments. The algorithm could also be adapted for use in industries such as fashion, where personalized clothing recommendations could be made based on individual physical characteristics and style preferences. Additionally, the algorithm could be used in the field of agriculture to create personalized fertilizer or pesticide recommendations for specific crops based on genetic markers.

The disclosure or parts thereof may be embodied as a method, system, or computer program product. Accordingly, the features disclosed herein, or at least some of the features, may take the form of an entirely hardware embodiment, an entirely software embodiment (including firmware, resident software, micro-code, etc.) or an embodiment combining software and hardware aspects all generally referred to herein as a “circuit” or “module.” Some of the disclosed features may be embodied in or performed by various processors, such as digital data processors or computers, wherein the computers are programmed or store executable programs of sequences of software instructions to perform one or more of the steps of the methods. Thus, features or at least some of the features disclosed herein may take the form of a computer program product on a non-transitory computer-usable storage medium having computer-usable program code embodied in the medium. The software instructions of such programs can represent algorithms and be encoded in machine-executable form on non-transitory digital data storage media.

Thus, portions of disclosed examples may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter. Configured or configured to means, for example, designed, constructed, or programmed, with the necessary logic and/or features for performing a task or tasks (and/or function or functions).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Other and further additions, deletions, substitutions and modifications may be made to the described embodiments.

Disclosed herein are various aspect including the apparatuses, systems, and methods as noted in the Summary. Each of the noted aspects can have one or more of the additional features of the below dependent claims in combination.

What is claimed:

1. A method of generating personalized skincare product recommendations, comprising:
receiving user data that includes metadata and biologic data of a person;
generating multi-omic heatmaps that represent correlations among the biologic data and omic data;
determining, using a first neural network that is trained on a knowledge graph derived from multi-omic datasets, correlations between biological markers identified from the biologic data and adverse reactions to one or more skincare product ingredients;
generating a prompt context for a large language model (LLM) from the metadata and the multi-omic heatmaps, wherein the LLM is configured as a Biologically Embodied Multilayer Analysis System (BeMAS) with a Mixture of Experts (MoE) architecture; and
producing, using the prompt context and the LLM a personalized skincare product recommendation for the person that excludes products predicted to cause the adverse reactions.

2. The method as recited in claim 1, wherein the metadata includes genetic data, product preferences, and the omic data of the person.

3. The method as recited in claim 1, wherein at least part of the receiving is via an intuitive web interface or a mobile application that is configured to dynamically refine questions based on user interaction.

4. The method as recited in claim 1, wherein the determining includes integrating contextual information of the metadata with sequencing data of the biologic data.

5. The method as recited in claim 1, wherein the biologic data includes biological sequencing data and the determining includes using the multi-omic heatmaps that represent the biological sequencing data.

6. The method as recited in claim 1, wherein the LLM is a second neural network.

7. The method as recited in claim 6, wherein the generating the prompt context includes embedding the multi-omic heatmaps into a structured representation interpretable by the LLM.

8. The method as recited in claim 7, wherein the biologic data includes biological sequencing data and skin microbiome data.

9. The method as recited in claim 1, wherein the biologic data is acquired through biosensing hardware.

10. A computing system for generating personalized skincare product recommendations, comprising:
an interface configured to receive user data that includes metadata and biologic data of a person; and
one or more neural networks (NNs) to perform operations that include:
generating multi-omic heatmaps that represent correlations among the biologic data and omic data;
determining, using a first one of the one or more neural networks that is trained on a knowledge graph derived from multi-omic datasets, correlations between biological markers identified from the biologic data and adverse reactions to one or more skincare product ingredients;
generating a prompt context for a large language model (LLM) from the metadata and the multi-omic heatmaps, wherein the LLM is configured as a Biologically Embodied Multilayer Analysis System (BeMAS) with a Mixture of Experts (MoE) architecture; and
producing, using the prompt context and the LLM a personalized skincare product recommendation for the person that excludes products predicted to cause the adverse reactions.

11. The computing system as recited in claim 10, wherein the metadata includes genetic data and the omic data of the person.

12. The computing system as recited in claim 10, wherein the interface includes an intuitive web interface that is configured to obtain the metadata by dynamically refining questions based on interactions of the person.

13. The computing system as recited in claim 10, wherein the determining includes integrating contextual information of the metadata with sequencing data of the biologic data.

14. The computing system as recited in claim 13, wherein the multi-omic heatmaps represent the sequencing data.

15. The computing system as recited in claim 10, wherein the biologic data includes biological sequencing data and skin microbiome data.

16. The computing system as recited in claim 10, wherein the omic data includes genomic and transcriptomic data.

17. A computing system, comprising:
one or more processors configured to perform operations, wherein the operations include:
processing metadata and biological sequencing data of a person, wherein the processing includes integrating contextual information of the metadata with the biological sequencing data;
generating multi-omic heatmaps representing sequencing data from the biologic data, wherein the multi-omic heatmaps identify biological markers according to knowledge graphs derived from multi-omic datasets;
identifying correlations between the biological markers and adverse reactions to one or more ingredients of one or more beauty products; and
generating a personalized beauty product recommendation for the person according to the correlations and the metadata, wherein the personalized beauty product recommendation excludes the one or more beauty products associated with the adverse reactions.

18. The computing system as recited in claim 17, further comprising a data reservoir including a beauty product database that includes the one or more beauty products and the ingredients thereof, a multi-omic knowledge graph database, or both.

19. The computing system as recited in claim 17, wherein the beauty products are skincare products and the metadata includes product preferences.

20. The computing system as recited in claim 19, wherein the operations further include aggregating the personalized beauty product recommendation with personalized recommendations of other users and developing new skincare products according to the aggregated personalized beauty product recommendations.
